(19) United States
(12) Patent Application Publication
(10) Pub. No.: US 2012/0100350 A1
(43) Pub. Date: Apr. 26, 2012

(54) TOP SHEET FOR DISPOSABLE DIAPER AND SANITARY PAD WITH IMPROVED SKIN FRIENDLINESS

(75) Inventor: Jae Hun Shim, Chungcheongnam-do (KR)

(73) Assignees: UPC LTD., Nonsan-si, Chungcheongnam-do (KR); Jae Hun SHIM, Gongju-si, Chungcheongnam-do (KR)

(21) Appl. No.: 13/127,472

(22) PCT Filed: Nov. 3, 2009
(86) PCT No.: PCT/KR2009/006421

§ 371 Date: Oct. 6, 2011

(30) Foreign Application Priority Data
Nov. 3, 2008 (KR) 10-2008-0108634

(51) Int. Cl. B32B 3/00

(52) U.S. Cl. 428/195.1

(57) ABSTRACT

Provided is a top sheet for a disposable diaper and sanitary pad which is prepared by manufacturing a perforated hydrophobic nonwoven having a weight of 25 g/m² or less, and embossing/laminating the nonwoven and an absorbent material through thermal adhesion or ultrasonic adhesion. Conventional hydrophilic nonwovens commonly used as top sheets for disposable diapers and sanitary pads have suffered from the major shortcoming that they cause skin irritation. Unlike conventional hydrophilic nonwovens, the novel perforated hydrophobic nonwoven used as the top sheet for a diaper according to the present invention are provided with decreased skin irritation and improved skin friendliness and dryness. The process for manufacturing a disposable diaper or sanitary pad using a perforated nonwoven alone may cause problems. The nonwoven top sheet of the present invention has functions and roles to overcome such problems caused by using the perforated nonwoven alone. Furthermore, less lint is produced on the surface of the nonwoven top sheet during the process of embossing/laminating the perforated hydrophobic nonwoven having a weight of 25 g/m² or less and the absorbent material through thermal adhesion or ultrasonic adhesion. Furthermore, the surface of the nonwoven top sheet of the present invention is patterned or dimpled during embossing/laminating, thereby reducing the area contacting the skin of a user. As described above, the nonwoven top sheet for a sanitary pad and diaper has a reduced amount of surface active agent contacting the skin of the user, has less lint on the surface thereof, and has a reduced area contacting the skin of the user, thereby having improved skin friendliness.

### TECHNICAL FIELD

The present invention relates to a top sheet of a disposable diaper and a sanitary pad. The disposable diaper or sanitary pad includes a top sheet covering an absorbent core and a back sheet. The top sheet of the disposable diaper and sanitary pad according to the present invention is a material of cotton which directly contacts the skin of a user.

### BACKGROUND ART

A top sheet of a disposable diaper and a sanitary pad should not cause skin irritation, feel soft, transmit moisture promptly to an absorbent core and provide good dryness without any lint, which are favorable and important factors in quality. A conventional top sheet of a disposable diaper and a sanitary pad has its focus on quick absorption and the feeling to the skin, and thus employs a hydrophilic nonwoven for the area contacting the skin, or a perforated plastic film which is not moist. The hydrophilic nonwoven which is used as the top sheet of the sanitary pad or disposable diaper has a hydrophilic agent of a kind of a surface active agent coated on the surface thereof. The hydrophilic agent which is used for the nonwoven contacting the skin irritates the weak skin of babies and women and is not dried easily after absorbing liquid. For sanitary pads, a nonwoven which is coated with a hydrophilic agent of a kind of a surface active agent or a nonwoven of a kind of spunlace including cotton and rayon thread is mainly used.

The rayon thread is processed by poisonous chemicals and chemical gas and may include pollutant and the remainder of the chemicals. To that end, using the rayon thread is not favorable nor dries well.

If the material contacting the skin includes chemicals to provide a hydrophilic nature (surface active agent), the chemicals cause the skin irritation, absorb liquid and thus the material does not dry well. If the hydrophilic nonwoven top sheet contacts the skin for a long time, it weakens and irritates the skin to harm the weak skin. The surface active agent is known to be bad for the skin, and cleansing oil or cleansing cream which removes the makeup is advertised focusing on non-existence of the surface active agent.

The perforated plastic film is widely used as the top sheet of a sanitary pad, and has good dryness but absorbs too much sweat.

### DISCLOSURE

### Technical Problem

The skin trouble is continuously found among users of a disposable diaper or sanitary pad, and complaints are being raised by consumers.

The present invention has been made to solve the problems and it is an object of the present invention to provide a top sheet of a disposable diaper or a sanitary pad which is more skin-friendly.

Another aspect of the present invention is to provide a top sheet of a disposable diaper or a sanitary pad which contacts the skin for a long time. If a nonwoven top sheet includes a hydrophilic agent (surface active agent), it irritates the weak skin. In this regard, it is absolutely essential to provide a top sheet excluding the hydrophilic agent. Further, if the top sheet absorbs moisture and contacts the weak skin for a long time, it causes diaper rash or irritates the skin and is not good for the skin. Accordingly, a material of a top sheet of a disposable diaper or sanitary pad which is dried easily and transmits moisture to an internal core is provided. Such function allows the nonwoven used as a top sheet of a disposable diaper and a sanitary pad to be quickly separated from moisture after contact and to be dried faster than a conventional hydrophilic nonwoven top sheet.

Another aspect of the present invention is to provide a material of a top sheet of a diaper or sanitary pad which has a reduced contact area with the skin and is more skin-friendly.

Another aspect of the present invention is to provide a material of a top sheet of a diaper or sanitary pad which reduces lint caused from the nonwoven top sheet, creates concave and convex parts on the surface of the nonwoven top sheet to reduce a contact area with the skin and is skin-friendly.

Another aspect of the present invention is to provide an unwoven top sheet which is easy to assemble and use during a manufacturing process for a disposable diaper and sanitary pad.

### Technical Solution

In order to achieve the object of the present invention, a nonwoven top sheet which is used for a disposable diaper and a sanitary pad and contacts the skin is manufactured by embossing/laminating a perforated hydrophobic nonwoven, which is pin-punched and has a weight of 25 g/m² or less, with an absorbent nonwoven or paper tissue, either by thermal adhesion or ultrasonic adhesion, by forming a water pipe to transmit moisture to the punched hydrophobic nonwoven, wherein the perforation of the hydrophobic nonwoven is performed by pin-punching the nonwoven by one of a pin roll and a pin plate in which a body area of a pin occupies 10% or more of a bottom area, to thereby improve the transmission of the moisture with the arrangement of the water pipe, and reduces a lint from the hydrophobic perforated nonwoven by the embossing/lamination process and extends less in a lengthwise direction of the hydrophobic perforated nonwoven by the embossing/lamination process.

The hydrophobic nonwoven with the weight of 25 g/m² or less comprises one of a polypropylene spun-bonded nonwoven, a nonwoven comprising the polypropylene spun-bonded nonwoven and a melt-blown nonwoven in at least two layers, a bi-component nonwoven comprising polypropylene and polyethylene, a nonwoven comprising polypropylene thread, a polyolefin nonwoven, a hydrophobic air-through nonwoven, and a hydrophobic thermal-bonded nonwoven.

The hydrophobic nonwoven with the weight of 25 g/m² or less comprises one of a polyolefin nonwoven whose absorption rate is 50% or less of that of a typical hydrophilic nonwoven and which is manufactured by a polyolefin material added with a hydrophilic additive, a nonwoven which is slightly processed by a hydrophilic agent and a nonwoven mixed with hydrophobic thread.

The absorbent nonwoven comprises one of an air-through nonwoven, an airlaid nonwoven, a spunlace nonwoven, a thermal-bonded nonwoven, a nonwoven comprising a polypropylene fiber processed with a hydrophilic agent, a nonwoven comprising a bi-component fiber mixed with polypropylene coated with a hydrophilic agent and polyethylene, a nonwoven comprising a polyolefin fiber coated with a hydrophilic agent, and a nonwoven comprising at least one of pulp rayon thread and polyester fiber.

Concave or convex parts are formed on a surface of the nonwoven top sheet by the embossing/lamination process.

### Advantageous Effect

As described above, the top sheet of the disposable diaper or sanitary pad according to the present invention has a hydrophobic nonwoven contact the skin to provide good dryness, does not include or uses less chemicals (surface active agent) such as a hydrophilic agent to thereby reduce skin irritation due to the chemicals, has the hydrophobic nonwoven perforated and laminated with the absorbent material in part to arrange water pipes in perforated holes and to grant the moisture transmission function to the hydrophobic nonwoven to thereby improve the absorption nature and increase the volume of cushion of the hydrophobic perforated nonwoven. As the hydrophobic perforated nonwoven is embossed/laminated with the absorbent material by ultrasonic adhesion or thermal adhesion, lint of the perforated nonwoven is reduced, and convex or concave parts are formed on the surface of the nonwoven top sheet to thereby reduce the area contacting the skin, provides good appearance and improves workability in manufacturing diaper and sanitary pad.

### BRIEF DESCRIPTION OF DRAWINGS

FIG. 1 illustrates a process of perforating a nonwoven.

FIG. 2 illustrates a laminating/embossing process by thermal adhesion.

FIG. 3 illustrates a laminating/embossing process by ultrasonic adhesion.

### BEST MODE

To achieve the foregoing objective, the present invention provides a top sheet of a disposable diaper and sanitary pad by manufacturing a perforated hydrophobic nonwoven having a weight of 25 g/m² or less and embossing/laminating the nonwoven and an absorbent material. The hydrophobic nonwoven top sheet according to the present invention is used as the top sheet of a disposable diaper and sanitary pad, is quickly dried upon contact of moisture, is drier when contacting the skin than the conventional hydrophilic nonwoven top sheet to thereby protect weak skin and does not include chemicals (surface active agent) and reduces skin irritation due to the chemicals. Also, as the chemicals (surface active agent) are less used, the top sheet of the disposable diaper and sanitary pad according to the present invention reduces skin irritation due to the chemicals.

The hydrophobic perforated nonwoven is laminated/embossed with an absorbent material, and thus is easy to assemble and use during a manufacturing process of a disposable diaper and sanitary pad.

The present invention provides a top sheet of a disposable diaper and sanitary pad which absorbs less water, and transmits secretion efficiently to an absorbent core of the disposable diaper and sanitary pad.

According to the present invention, a hydrophobic nonwoven is perforated to use a hydrophobic nonwoven, which absorbs less water, as a top sheet. Then, the perforated nonwoven is embossed/laminated in part with an absorbent material. The absorbent material includes an absorbent nonwoven or paper tissue in at least one fold which is embossed/laminated in part to grant the absorption nature for transmitting moisture. The nonwoven top sheet according to the present invention has a hydrophobic nonwoven contacting the skin to thereby maintain a healthy contact status and arrange a water pipe in a punched hole to efficiently transmit secretion to the absorbent core. At the time of embossing/laminating the nonwoven according to the present invention, concave or convex parts are formed on a surface of the nonwoven top sheet to thereby reduce the contact area with a user's skin and the occurrence of lint from the nonwoven fiber. The nonwoven top sheet of the disposable diaper or sanitary pad according to the present invention includes a pin-punched hydrophobic nonwoven with a weight of 25 g/m² or less and absorbing less water. The pin-punching operation is performed by using a pin roll or a pin plate in which a diameter area of a pin occupies 10% or more of the entire area to punch the hydrophobic nonwoven and manufacture a hydrophobic perforated nonwoven with a weight of 25 m² or less.

The hydrophobic perforated nonwoven with the weight of 25 m² or more is thick and the degree of absorption is not sufficient and material cost rises even if it is pin-punched.

According to the present invention, the hydrophobic perforated nonwoven with the weight of 25 m² or less is embossed/laminated with an absorbent material which absorbs water. The laminating (adhering) method is to emboss/laminate the hydrophobic perforated nonwoven (which will be arranged in a water pipe) by thermal adhesion or ultrasonic adhesion.

The concept of the absorbent material according to the present invention includes a concept of a surge layer.

In general, application of a perforated nonwoven only may be inconvenient in manufacturing a diaper or sanitary pad.

This is because the perforated nonwoven extends well in a lengthwise direction (mechanical direction), deteriorating stability of width and causing weak strength. The top sheet according to the present invention includes the perforated nonwoven embossed/laminated with the absorbent material to provide good stability of width and strong tensile strength and does not easily extend in the mechanical direction to thereby improve workability of the perforated nonwoven top sheet.

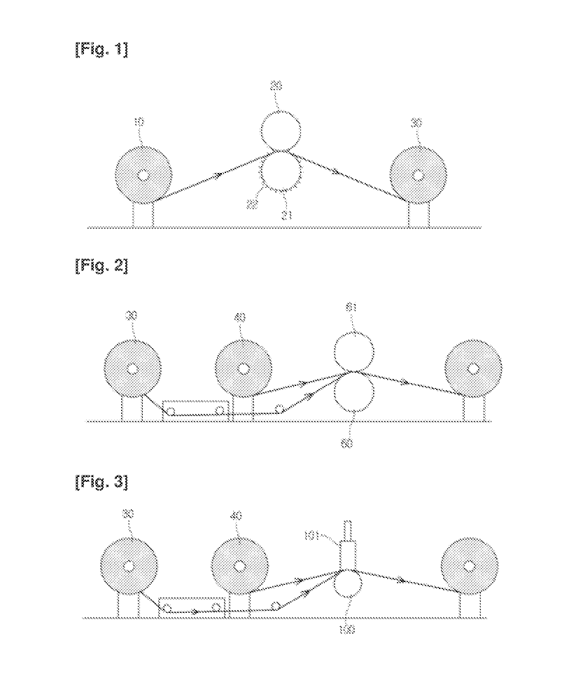

To use a hydrophobic nonwoven 10 (refer to FIG. 1) as a top sheet, the hydrophobic nonwoven 10 with the weight of 25 m² or less is perforated by a pin roll 21 (refer to FIG. 1) or pins 22 (refer to FIG. 1) of a pin plate (refer to FIG. 1) of a pin plate in which a body area of the pins occupies 10% or more of the entire area to manufacture a hydrophobic perforated nonwoven 30 (refer to FIG. 1) with a weight of 25 m² or less, which is embossed/laminated with an absorbent material by thermal adhesion or ultrasonic adhesion to arrange a water pipe therein for manufacturing a nonwoven top sheet with good dryness.

If the nonwoven used for manufacturing the top sheet weighs 25 m² or more, empty spaces in the nonwoven are reduced and the composition of the water pipe by the punch holes deteriorates. Also, the quantity of materials used for the top sheet increases, cost-effectiveness becomes worse. According to the test, a preferable nonwoven weighs 10 to 20 g/m².

The larger the perforation area of the nonwoven is, the better the water pipe is formed and the nonwoven absorbs liquid (permeate liquid). The perforation method of the nonwoven is to perforate the nonwoven by the pin punch 22 (refer to FIG. 1) by using the pin roll 21 (refer to FIG. 1) and pin plate. A counter-roll 20 of the pin roll in FIG. 1 includes a roll having holes corresponding to the pins, or an iron scrubber roll or a brush roll. The perforation by the pin punching of the pin roll and pin plate preserves the touch of the nonwoven, prevents the direct contact of the hydrophilic nonwoven to the skin even if the water pipe is formed, forms a space in a certain thickness, and covers the absorbent nonwoven where the perforated holes (water pipes) are not formed. The pin which is suitable for the pin punching as above has a sharp edge, and a body of the pin has a predetermined area to form the pin hole. The pin plate or the pin roll includes an area where the pin exists and an area where the pin does not exist. The body area of the pin and the entire area including the pin area and the unpin area should maintain a certain ratio as in Formula I below.

The body area of the pin (%)=the body area of the pin/(bottom area=body area of the pin+unpin area out of bottom area)×100 Formula 1.

In Formula I, the rate of the body area of the pin is in proportion to the perforated area of the perforated nonwoven. In the case of punching the nonwoven, a preferable ratio of the body area of the pin with respect to the bottom area is 10% or more.

The top sheet of the disposable diaper or sanitary pad is manufactured by embossing/laminating the perforated nonwoven with the absorbent material by thermal adhesion or ultrasonic adhesion.

As the perforated hydrophobic nonwoven is embossed/laminated with the absorbent nonwoven, the water pipes are arranged in the punch holes of the perforated nonwoven to grant the water transmitting function.

As the perforated hydrophobic nonwoven is embossed/laminated with the absorbent nonwoven, lint of the hydrophobic perforated nonwoven is reduced.

The nonwoven is laminated with the absorbent material by thermal adhesion or ultrasonic adhesion, and such lamination prevents occurrence of allergy due to hot melt or adhesive and preserves skin friendliness of the top sheet.

In the case of the thermal adhesion or ultrasonic adhesion, the punched hydrophobic nonwoven 30 is laminated with the absorbent material (absorbent nonwoven and paper tissue) by the embossed roll.

The absorbent nonwoven and paper tissue which are the absorbent material 40 (refer to FIG. 2) according to the present invention are laminated in at least one fold.

In the case of the thermal adhesion (refer to FIG. 2), the perforated hydrophobic nonwoven 30 and the absorbent material (absorbent nonwoven and paper tissue 40) are supplied between an embossing roll 60 and a pressure roll 61, which are heated at the adhesion temperature, and then are patterned by embossing adhesion and embossed/laminated in part.

In the case of the ultrasonic adhesion (refer to FIG. 3), the hydrophobic perforated nonwoven 30 and the absorbent material 40 are supplied between the embossing roll 100 and an ultrasonic horn 101 to be pressed by the ultrasonic horn 101 and then embossed/laminated.

The nonwoven which contacts the embossing roll 100 may employ the hydrophobic nonwoven or the absorbent nonwoven wherever necessary.

The embossing/laminating process performed by the foregoing thermal adhesion or ultrasonic adhesion slightly melts the perforated hydrophobic nonwoven on the line and spot of the embossing pattern at the time of lamination to ensure the melt adhesion of the absorbent material and thus the lint on the surface of the perforated hydrophobic nonwoven is reduced.

According to the present invention, when at least two materials are embossed/laminated in part, the nonwoven is melt and adhered to the embossing line or spot of the nonwoven and decreases in thickness. Such difference in thickness and partial lamination creates concave or convex parts on the surface of the nonwoven top sheet.

The concave or convex part formed on the surface of the nonwoven top sheet reduces the contact area with a user's skin and protects a user's skin.

The embossing/lamination according to the present invention generates pretty embossing lines or patterns.

Also, the embossing/lamination according to the present invention provides a good appearance and improves the value of the top sheet.

If the hydrophobic nonwoven is perforated, the amount of lint increases compared to that of the nonwoven before perforation.

The increased lint is fatal to the quality of the top sheet. The top sheet according to the present invention has the reduced lint of the perforated nonwoven by the embossing/lamination.

The embossing/lamination process is not performed in whole, and the pattern of the embossing roll may include all types of embossing patterns.

The hydrophobic nonwoven which is used as the top sheet of the disposable diaper or sanitary pad may include a polyolefin hydrophobic nonwoven such as a polypropylene spun-bonded nonwoven, a nonwoven including a polypropylene spun-bonded nonwoven and a melt-blown nonwoven in at least two layers, a bi-component nonwoven including polypropylene and polyethylene, a nonwoven including propylene copolymer and a nonwoven including polypropylene thread; an air-through nonwoven including hydrophobic thread; or a thermal-bonded nonwoven including hydrophobic thread.

The hydrophobic nonwoven according to the present invention includes a typical hydrophilic nonwoven and the hydrophobic nonwoven with the absorption rate of less than 50%.

This reduces the application of the hydrophilic agent to the nonwoven top sheet, and meets the purpose of the present invention even if the contact rate of the surface active agent (hydrophilic agent) is reduced to 50% or less.

Such nonwovens may include a nonwoven including a polyolefin material and a hydrophilic agent, a nonwoven slightly coated with a hydrophilic agent and having an absorption rate of 50% or less and a nonwoven including hydrophobic thread.

Among the absorbent materials adhered to the hydrophobic perforated nonwoven, the absorbent nonwoven may include an air through nonwoven, an airlaid nonwoven, a spunlace nonwoven, a thermal-bonded nonwoven, a nonwoven including a polyolefin fiber coated with a hydrophilic agent, and a nonwoven including at least one of pulp rayon thread and polyester fiber. Among the absorbent materials, the paper tissue may include paper tissue used as napkin, tissue, facial tissue or other similar paper tissue.

The absorbent material may include the absorbent nonwoven and paper tissue which are laminated in two folds.

The absorbent material may further include the absorbent nonwoven, paper tissue and absorbent nonwoven in three folds.

According to the present invention, the top sheet is manufactured by laminating the hydrophobic perforated nonwoven with the absorbent nonwoven and the paper tissue.

The top sheet is manufactured by laminating the above materials in at least one fold.

The nonwoven absorption layer which is formed in a surface of the hydrophobic perforated nonwoven improves the absorption nature of the perforated nonwoven and increases the volume of cushion, as the top sheet of the disposable diaper or sanitary pad.

The top sheet of the sanitary pad and diaper according to the present invention uses less surface active agent contacting a user's skin, reduces lint from the nonwoven by the embossing/lamination process, and forms concave and convex parts on the surface of the nonwoven top sheet to reduce the contact area with a user's skin and to be more skin-friendly.

### First Exemplary Embodiment

Manufacturing of the Top Sheet Material (Perforation of the Hydrophobic Nonwoven and Lamination of the Absorbent Nonwoven)

For the hydrophobic nonwoven, a polypropylene spun-bonded nonwoven with a weight of 13 g/m² was used.

The nonwoven was punched by the pin roll.

A body area of the pin in the pin roll occupies 42% of a bottom area thereof.

The hydrophobic perforated nonwoven was embossed/laminated with a hydrophilic air-through nonwoven with a weight of 20 g/m² by ultrasonic adhesion.

The adhesion pattern of the laminating/embossing roll included a diamond line pattern which is 7 mm in length and 1 mm in width.

Along the adhesion pattern shaped like a diamond line, the hydrophobic perforated nonwoven and the hydrophilic nonwoven were adhered.

(Result of the Test According to the First Exemplary Embodiment)

The lint of the perforated nonwoven before and after embossing/lamination were compared.

When rubbed by hand, it was confirmed by naked eyes that the lint of the nonwoven fiber has been reduced after the embossing/laminating process. Also, it was confirmed by naked eyes that the concave and convex parts were formed on the surface along the embossing line. According to the analysis result of dryness of the nonwoven top sheet according to the first exemplary embodiment and the conventional hydrophilic nonwoven top sheet, the nonwoven top sheet according to the first exemplary embodiment shows better dryness than the conventional top sheet while the absorption rate of the former top sheet is similar to that of the latter.

### Second Exemplary Embodiment

The nonwoven top sheet according to the present exemplary embodiment is the same as that according to the first exemplary embodiment except that the nonwoven top sheet (hydrophobic perforated top sheet) was laminated with paper tissue with a weight of 21 g/m² and a hydrophilic air-through nonwoven with a weight of 20 g/m².

The test result was similar to that according to the first exemplary embodiment.

### Third Exemplary Embodiment

Manufacturing of Diaper

A disposable diaper was manufactured by using the nonwoven top sheet according to the first exemplary embodiment.

### Fourth Exemplary Embodiment

Manufacturing of Sanitary Pad

A sanitary pad was manufactured by using the nonwoven top sheet according to the first exemplary embodiment.

### Fifth Exemplary Embodiment

Test of Products According to the Third and Fourth Exemplary Embodiments

The products according to the third and fourth exemplary embodiments were provided to consumers to test the effect of usage.

Test Results of Products Provided to Consumers

1. According to the comparison result of the sanitary pad according to the fourth exemplary embodiment and a sanitary pad released in the market and employing the conventional hydrophilic nonwoven top sheet, the sanitary pad according to the fourth exemplary embodiment causes less rash and skin irritation.

2. According to the comparison result of the disposable diaper according to the third exemplary embodiment and a disposable diaper released in the market and employing the conventional hydrophilic nonwoven top sheet, the diaper according to the third exemplary embodiment causes less rash and skin irritation.

1. A nonwoven top sheet which is used for a disposable diaper and a sanitary pad and contacts the skin, wherein the nonwoven top sheet is manufactured by embossing/laminating a perforated hydrophobic nonwoven, which is pin-punched and has a weight of 25 g/m² or less, with an absorbent nonwoven or paper tissue, either by thermal adhesion or ultrasonic adhesion, by forming a water pipe to transmit moisture to the punched hydrophobic nonwoven, wherein the perforation of the hydrophobic nonwoven is performed by pin-punching the nonwoven by one of a pin roll and a pin plate in which a body area of a pin occupies 10% or more of a bottom area, to thereby improve the transmission of the moisture with the arrangement of the water pipe, and reduces a lint from the hydrophobic perforated nonwoven by the embossing/lamination process and extends less in a lengthwise direction of the hydrophobic perforated nonwoven by the embossing/lamination process.

2. The nonwoven top sheet according to claim 1, wherein the hydrophobic nonwoven with the weight of 25 g/m² or less comprises one of a polypropylene spun-bonded nonwoven, a nonwoven comprising the polypropylene spun-bonded nonwoven and a melt-blown nonwoven in at least two layers, a bi-component nonwoven comprising polypropylene and polyethylene, a nonwoven comprising polypropylene thread, a polyolefin nonwoven, a hydrophobic air-through nonwoven, and a hydrophobic thermal-bonded nonwoven.

3. The nonwoven top sheet according to claim 1, wherein the hydrophobic nonwoven with the weight of 25 g/m² or less comprises one of a polyolefin nonwoven whose absorption rate is 50% or less of that of a typical hydrophilic nonwoven and which is manufactured by a polyolefin material added with a hydrophilic additive, a nonwoven which is slightly processed by a hydrophilic agent and a nonwoven mixed with hydrophobic thread.

4. The nonwoven top sheet according to claim 1, wherein the absorbent nonwoven comprises one of an air-through nonwoven, an airlaid nonwoven, a spunlace nonwoven, a thermal-bonded nonwoven, a nonwoven comprising a polypropylene fiber processed with a hydrophilic agent, a nonwoven comprising a bi-component fiber mixed with polypropylene coated with a hydrophilic agent and polyethylene, a nonwoven comprising a polyolefin fiber coated with a hydrophilic agent, and a nonwoven comprising at least one of pulp rayon thread and polyester fiber.

5. The nonwoven top sheet according to claim 1, wherein concave or convex parts are formed on a surface of the nonwoven top sheet by the embossing/lamination process.
